(19) United States
(12) Patent Application Publication
(10) Pub. No.: US 2007/0105015 A1
(43) Pub. Date: May 10, 2007

(54) Battery and method of producing the same

(76) Inventors: Noriyoshi Munenaga, Kyoto-shi (JP); Isao Suzuki, Hirakata-shi (JP); Takeshi Shimozono, Otokuni-gun (JP); Tetsuzo Kojima, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/583,583

(22) PCT Filed: Dec. 22, 2004
(86) PCT No.: PCT/JP04/19686

§ 371 Date: Jun. 19, 2006

(30) Foreign Application Priority Data
Dec. 24, 2003 (JP) 2003-426213

(51) Int. Cl. H01M 2/26; H01M 10/04

(52) U.S. Cl. 429/161; 429/211; 29/623.1

(57) ABSTRACT

A battery including: a power generating element having a positive electrode, a negative electrode, and a separator; a battery case for housing the power generating element; a battery cover for closing the battery case; and a lead for electrically connecting a terminal provided for the battery cover and the positive electrode or the negative electrode, wherein a part in which the lead and the positive electrode or the negative electrode are electrically connected to each other is sandwiched by an insulating member.

### BACKGROUND OF THE INVENTION

1. Technical Field

The present invention relates to a battery in which a power generating element is housed in a battery case and covered with a battery cover, and a terminal provided for the battery cover is connected to an electrode of the power generating element via a lead.

2. Background Art

FIG. 4 shows an example of conventional configuration of a nonaqueous electrolyte secondary battery. In the nonaqueous electrolyte secondary battery, a power generating element 1 is housed in a battery case 2 and an opening end of the battery case 2 is covered with a battery cover 3. The power generating element 1 is obtained by winding band-shaped positive and negative electrodes 1a and 1b via a separator 1c in an elliptic cylindrical shape. The positive electrode 1a is obtained by coating the surface of band-shaped aluminum foil as a current collector base material with a positive active material, and the negative electrode 1b is obtained by coating the surface of band-shaped copper foil as a current collector base material with a negative active material. By providing a portion which is not coated with an active material (active material non-coating portion) in a side edge of the band shape in each of the positive and negative electrodes 1a and 1b and winding the positive and negative electrodes 1a and 1b while being shifted vertically in the winding axis direction, the aluminum foil in the active material non-coating portion of the positive electrode 1a is projected in an upper end of the power generating element 1, and the copper foil of the active material non-coating portion of the negative electrode 1b is projected in the lower end.

The battery case 2 is obtained by forming a stainless steel plate into an almost deep angular case shape, and an upper hidden end of the angular case is an opening end. The battery cover 3 is constructed by a stainless steel plate having an almost rectangular shape which is fit in the opening end of the battery case 2. In the battery cover 3, as shown in FIG. 5, a projection 4a projecting downward from the under face of a positive electrode terminal 4 made of an aluminum alloy penetrates the top and under faces via terminal insulation-sealing members 5 and 6. Moreover, the projection 4a of the positive electrode terminal 4 is connected and fixed to a positive electrode lead 7 made of an aluminum alloy via the terminal insulation-sealing member 6 by caulking on the under face of the battery cover 3. Specifically, the body of the positive electrode terminal 4 is disposed on the surface of the battery cover 3 via the terminal insulation-sealing member 5, and the projection 4a projected from the under face of the terminal body penetrates via holes in the terminal insulation-sealing member 5, the battery cover 3, the terminal insulation-sealing member 6, and the positive electrode lead 7 and caulked. Therefore, the body of the positive electrode terminal 4 positioned on the side of the battery cover 3 is insulation-sealed with respect to the battery cover 3, and the projection 4a penetrates to the under face side and is connected and fixed to the positive electrode lead 7.

The positive electrode lead 7 is constructed by a flat caulking plate part 7a caulked to the projection 4a of the positive electrode terminal 4 on the under face of the terminal insulation-sealing member 6, a lead part 7b perpendicularly led from an end of the caulking plate part 7a, and a U-shaped connection part 7c at the tip of the lead part 7b, and can be formed by punching and bending a single aluminum alloy plate. In each of both ends on the side close to the caulking plate part 7a and the side close to the connection part 7c of the lead part 7b of the positive electrode lead 7, a bending groove in which the plate thickness is slightly reduced to facilitate bending is formed.

The connection part 7c of the positive electrode lead 7 is inserted to the center of the winding of the aluminum foil of the positive electrode 1a projected in the elliptic cylindrical shape in the upper end portion of the power generating element 1. In a state where the aluminum foil overlaps with the outer periphery of the connection part 7c, the connection part 7c is connected and fixed in a plurality of U shaped positions by performing ultrasonic welding. Specifically, for example, as shown by arrows A and B in FIG. 5, ultrasonic welding is performed by pressing the connection part 7c and the aluminum foil overlapped with the connection part 7c while sandwiching them by an ultrasonic horn and applying ultrasonic vibrations. Therefore, the positive electrode terminal 4 is connected to the positive electrode 1a of the power generating element 1 via the positive electrode lead 7. Although not shown in FIG. 4, the U-shaped connection part of the negative electrode lead is similarly connected and fixed by ultrasonic welding to the copper foil of the negative electrode 1b projected from the lower end of the power generating element 1.

The power generating element 1 to which the positive electrode lead 7 and the negative electrode lead are connected and fixed as described above is housed on the inside via the upper end opening of the battery case 2. The negative electrode lead is pressed against the inner bottom face of the battery case 2 by the electrode chip inserted via the winding center of the power generating element 1 to perform spot welding. Therefore, the battery case 2 is connected to the negative electrode 1b of the power generating element 1 via the negative electrode lead and the battery case 2 itself serves as a negative pole terminal. As shown by arrows C and D in FIG. 5, by bending the bending grooves formed in both ends of the lead part 7b of the positive electrode lead 7 at the right angles in directions opposite to each other, the battery cover 3 is fit in the opening end of the battery case 2 as shown by the arrow E in FIG. 5, and the fit portion is sealed by laser welding or the like. A nonaqueous electrolyte solution is injected from a not-shown injection port formed in the battery cover 3, pre-charging is performed, and the injection port is sealed, thereby completing a nonaqueous electrolyte secondary battery.

### DISCLOSURE OF THE INVENTION

As described above, in the conventional nonaqueous electrolyte secondary battery, with the configuration such that the positive electrode lead 7 is connected and fixed to the positive electrode 1a of the power generating element 1 and, after that, the lead part 7b is bent and the battery cover 3 is fit in the opening end of the battery case 2, the ultrasonic horn for performing ultrasonic welding between the connection part 7c of the positive electrode lead 7 and the aluminum foil of the positive electrode 1a and the electrode chip for performing spot welding between the negative pole lead and the inner bottom face of the battery case 2 can be easily inserted to work sites.

In such a conventional nonaqueous electrolyte secondary battery, however, in the state where the positive electrode lead 7 is connected and fixed to the positive electrode 1a of the power generating element 1, the lead part 7b of the positive electrode lead 7 has to be bent. Consequently, the bending force is also applied to the connection part 7c, and it causes a problem such that the aluminum foil of the positive electrode 1a might be peeled off from the part connected and fixed to the connection part 7c.

If the side close to the caulking plate part 7a in the lead part 7b is just bent, by securely sandwiching and fixing the side close to the connection part 7c in the lead part 7b, the bending force is not applied to the connection part 7c. However, the aluminum alloy plate having some thickness is used in order to pass large discharge current to the positive electrode terminal 4 and to reduce the internal resistance of the battery, so that a large force is necessary to bend the lead part 7b. Moreover, the lead part 7b has to be bent in a position extremely close to the connection part 7c for miniaturization of the battery. Consequently, it is extremely difficult to avoid the influence of the bending force to the connection part 7c at the time of bending the lead part 7b. In view of those points, the present invention has been achieved.

The present invention is directed to solve the problem such that the electrode might be peeled off from the connected and fixed part at the time of sandwiching and fixing the connected and fixed part between the lead of the terminal and the electrode of the power generating element by using an insulating member.

The present invention provides a battery including: a power generating element having a positive electrode, a negative electrode, and a separator; a battery case for housing the power generating element; a battery cover for closing the battery case; and a lead for electrically connecting a terminal provided for the battery cover and the positive electrode or the negative electrode, characterized in that a part in which the lead and the positive electrode or the negative electrode are electrically connected to each other is sandwiched by an insulating member.

According to the invention, since the connected and fixed part between the lead and the positive electrode or the negative electrode of the power generating element is sandwiched by the insulating member, there is no danger such that the lead is peeled off from the positive electrode or the negative electrode at the time of bending the lead. Since the connection part between the lead and the positive electrode or the negative electrode is sandwiched by the member, when the battery is vibrated or shocked, the connection part between the lead and the positive electrode or the negative electrode is resistant to damage.

Preferably, the sandwiched member is fit in the battery case. “Fit” means a state where the surface of the member for sandwiching and the inner wall of the battery case are in contact with each other and the position of the member in the battery is held. However, the entire surface of the member does not have to be in contact with the inner wall of the battery case. The member fit in the battery case is supported, and the fit member supports the positive electrode or the negative electrode. Therefore, at the time of bending the lead, the bending force is hardly transmitted to the part in which the positive electrode or the negative electrode and the lead are electrically connected to each other. As a result, the danger such that the positive electrode or the negative electrode and the lead are peeled off from each other is reduced. Further, when the battery is vibrated or shocked, the part in which the lead and the positive electrode or the negative electrode are connected is not easily damaged.

Preferably, such a member presses the part in which the lead and the positive electrode or the negative electrode are electrically connected to each other. With the configuration, the part in which the lead and the positive electrode or the negative electrode are electrically connected to each other is supported, so that the bending force is not transmitted. To prevent transmission of the bending force, the member itself can have elasticity. For example, expanded polyethylene, expanded polypropylene, or the like can be used. By fitting the elastic member in the battery case, the member can press the part in which the lead and the positive electrode or the negative electrode are connected to each other.

As such a member, an insulating member is preferred for the reason that, even when the member comes into contact with any part in the battery, no short circuit occurs. Concretely, a resin such as polyethylene or polypropylene is preferable since those resins have resistance to an electrolyte solution used for the nonaqueous electrolyte secondary battery.

The member may be adhered to the battery case. For adhesion, a known conventional technique such as adhesion using an adhesive can be used.

The electrode sandwiched by the member may be the positive electrode and/or the negative electrode. In the case where both of the positive and negative electrodes are sandwiched, it is sufficient to use two battery covers that cover the battery case and sandwich the positive and negative electrodes on the upper end face and the lower end face of the battery.

The member may be only one member. Alternately, by combining a plurality of members, while being fit in the battery case, the members can sandwich the part in which the positive electrode or the negative electrode and the lead are connected to each other. With the configuration, the fitting work can be facilitated.

As the lead, a lead having a thickness of about 0.1 mm to 2 mm can be used. With such a thickness, the lead is strong. In addition, the part in which the lead and the positive electrode or the negative electrode are connected to each other is sandwiched, so that the battery is particularly resistant to vibration and shock. It is also preferable from the viewpoint of taking a heavy current from the power generating element.

The present invention also provides a method of manufacturing a battery including a power generating element having a positive electrode, a negative electrode, and a separator, a battery case for housing the power generating element, a battery cover for closing the battery case, and a lead for electrically connecting a terminal provided for the battery cover and the positive electrode or the negative electrode, and characterized by including: a step of electrically connecting the lead to the positive electrode or the negative electrode; a step of sandwiching the connection part by a member; a step of housing the power generating element in the battery case; and a step of bending the lead. The steps can be performed in various orders. When the step of bending the lead is performed after the step of sandwiching the connection part by a member, the effects of the present invention are exerted. By using such a method, the danger such that the positive electrode or the negative electrode and the lead are peeled off from each other at the time of bending the lead can be reduced.

As the lead, a lead having a thickness of about 0.1 mm to 2 mm can be used. Since a lead having such a thickness is strong, a large force is required to bend it. When the part in which the lead and the positive electrode or the negative electrode are connected to each other is sandwiched as in the present invention, even if a large force is applied, the danger that the lead is peeled off is small. Therefore, the effects of the present invention can be obtained markedly.

### BRIEF DESCRIPTION OF THE DRAWINGS

FIG. 1 is a partial longitudinal section of a portion around an opening in a battery case of a nonaqueous electrolyte secondary battery as an embodiment of the present invention.

FIG. 2 is a perspective view showing a positive electrode lead and an insulating member attached to a battery cover and an insulating member as an embodiment of the invention.

FIG. 3 is a partial longitudinal section showing another configuration example of a portion around an opening in a battery case of a nonaqueous electrolyte secondary battery as an embodiment of the invention.

FIG. 4 is an exploded perspective view showing a structure of a conventional nonaqueous electrolyte secondary battery

FIG. 5 is a partial longitudinal section for explaining a positive electrode lead bending work at the time of fitting the battery cover in the opening end in the battery case of the conventional nonaqueous electrolyte secondary battery.

Shown in the drawings are a power generating element 1, a positive electrode 1a, a battery case 2, a battery cover 3, a positive electrode terminal 4, a positive electrode lead 7, a lead part 7b, a connection part 7c, an insulating member 8, a center part 8a, a first side part 8b, and a second side part 8c.

### DESCRIPTION OF PREFERRED EMBODIMENT OF THE INVENTION

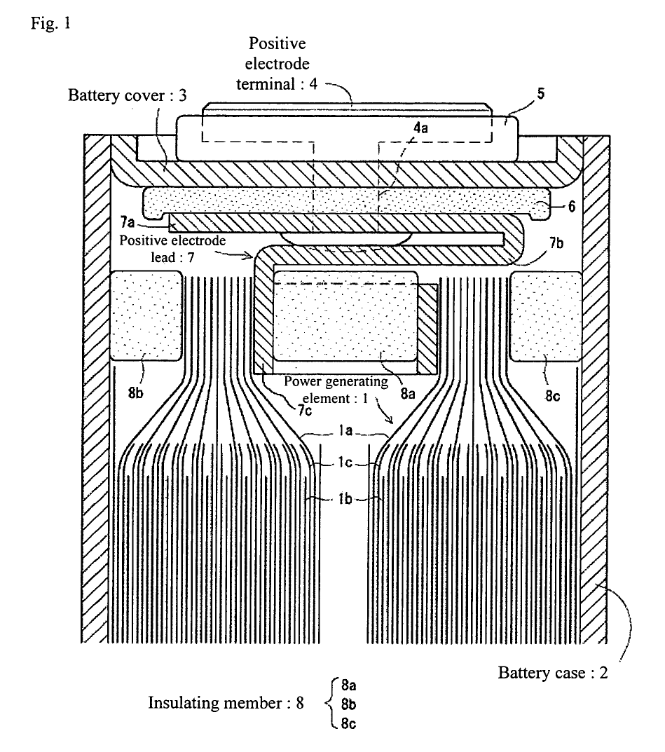

An embodiment of the present invention will be described with reference to FIGS. 1 to 3.

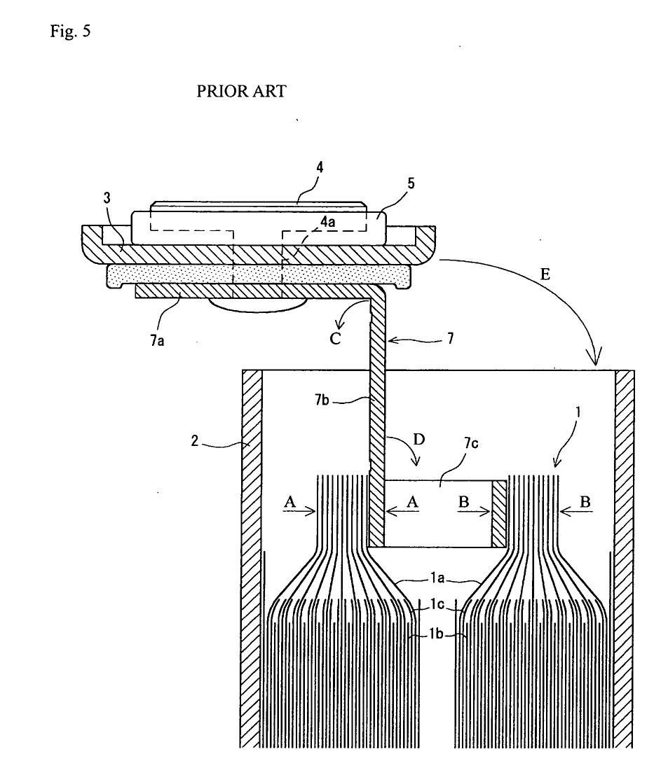

In the embodiment, a nonaqueous electrolyte secondary battery having a configuration similar to that of the conventional battery shown in FIGS. 4 and 5 will be described. In FIGS. 1 to 3, the same reference numerals are designated to components having functions similar to those of the conventional battery shown in FIGS. 4 and 5.

The configurations of the power generating element 1, the battery case 2, and the battery cover 3 of the nonaqueous electrolyte secondary battery of the embodiment are the same as those of the conventional battery. A configuration in which the positive electrode terminal 4 is insulation-sealed and fixed to the battery cover 3 via the terminal insulation-sealing members 5 and 6, and the positive electrode lead 7 is connected and fixed to the projection 4a of the positive electrode terminal 4 is also the same as that of the conventional battery.

The embodiment, however, is different from the conventional embodiment with respect to the point that an insulating member 8 is fit in the opening in the battery case 2 as shown in FIG. 1.

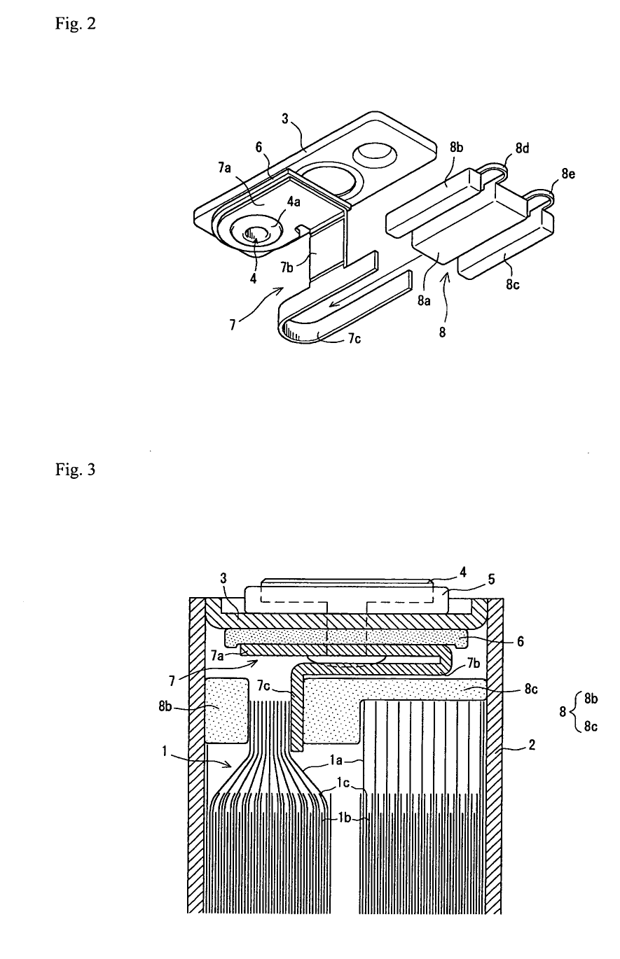

The insulating member 8 is a molded part of resin having a certain degree of rigidity and insulation property. As shown in FIG. 2, the insulating member 8 is constructed by a center part 8a having an almost rectangular parallelepiped shape, first and second side parts 8b and 8c, and spring parts 8d and 8e connecting the side parts 8b and 8c and the center part 8a. The center part 8a is an almost-rectangular-parallelepiped member having a width so that it fits in a U shape of the connection part 7c of the positive electrode lead 7 with almost no gap. The side parts 8b and 8c are narrow members each having an almost rectangular parallelepiped shape, which are disposed in parallel on both sides of the center part 8a with a gap. The spring parts 8d and 8e are curved members connecting the center part 8a and the side parts 8b and 8c with their ends. The spring parts 8d and 8e facilitates handling of the insulating member 8 as an integrated part, and play the role of a spring of energizing the side parts 8d and 8e so that the side parts 8d and 8e approach each other to predetermined distance by elasticity of the resin. The predetermined distance between the center part 8a and each of the side parts 8b and 8c supported by the spring parts 8d and 8e is set to be slightly smaller than the width of the connected and fixed part in which aluminum foil of the positive electrode 1a of the power generating element I is ultrasonic-welded to the outside of both plate pieces of the U shape in the connection part 7c of the positive electrode lead 7 shown in FIG. 1. The distance between the outer side faces of the side parts 8b and 8c on both sides is almost equal to or slightly wider than the width on the inside of the opening in the battery case 2.

The connection part 7c of the positive electrode lead 7 attached to the battery cover 3 and the aluminum foil of the positive electrode 1a of the power generating element 1 are ultrasonic welded and, after that, the insulating member 8 is attached to the connected and fixed part. That is, the center part 8a of the insulating member 8 is inserted in the U shape of the connection part 7c of the positive electrode lead 7, and the connected and fixed part in which the aluminum foil of the positive electrode 1a is ultrasonic-welded to the outside of a plate piece having the U shape of the connection part 7c is sandwiched between each of the side parts 8b and 8c and the center part 8a which are slightly widened. In this state, the power generating element 1 is inserted through the opening end into the battery case 2 and housed. Since the side parts 8b and 8c on both sides are slightly widened in the final stage of insertion of the power generating element 1, the insulating member 8 is press-fit in the opening of the battery case 2. Therefore, the side parts 8b and 8c on both sides of the insulating member 8 are pressed against the inside by press-fitting according to the width of the opening of the battery case 2, so that the insulating member 8 strongly sandwiches the connected and fixed part between the connection part 7c and the aluminum foil, and is fixed to the inside of the opening in the battery case 2.

When feasible, after the power generating element 1 is housed in the battery case 2, the insulating member 8 may be inserted in the opening in the battery case 2 and the connected and fixed part between the connection part 7c and the aluminum foil may be sandwiched between the center part 8a and each of the side parts 8b and 8c.

When the power generating element 1 is housed in the battery case 2 as described above, by bending the curved grooves formed in both ends of the lead part 7b in the opposite directions at the right angle in a manner similar to the conventional technique shown in FIG. 5, the battery cover 3 is fit in the opening end in the battery case 2. At the time of bending the lead part 7b of the positive electrode lead 7, the connection part 7c is sandwiched together with the aluminum foil of the positive electrode 1a of the power generating element 1 by the insulating member 8 and is fixed to the battery case 2. Consequently, shift or distortion does not occur in the connection part 7c due to the bending force, and there is no possibility that the aluminum foil is peeled off from the connected and fixed part due to the shift or distortion of the connection part 7c. When the battery cover 3 is fit in the opening in the battery case 2 as shown in FIG. 1, the fit part is sealed by laser welding or the like, a nonaqueous electrolyte solution is injected, pre-charging is performed, and a solution injection port is closed, thereby completing a nonaqueous electrolyte secondary battery.

As described above, in the nonaqueous electrolyte secondary battery of the embodiment, the connected and fixed part between the connection part 7c of the positive electrode lead 7 and the aluminum foil of the positive electrode 1a of the power generating element 1 is sandwiched and fixed by the insulating member 8. Consequently, even if the lead part 7b of the positive electrode lead 7 is bent to fit the battery cover 3 therein, the aluminum foil is not peeled off from the connected and fixed part. In the completed battery, since the lead and the positive electrode or negative electrode are sandwiched by the member, even if the battery is vibrated or shocked in the vertical or horizontal direction or backward or forward, the connection part between the lead and the positive electrode or negative electrode is not easily damaged.

In the foregoing embodiment, the case of integrating the center part 8a of the insulating member 8 and the side parts 8b and 8c via the spring parts 8d and 8e has been described. To sandwich and fix the connected and fixed part between the positive electrode lead 7 and the positive electrode 1a, the center part 8a and the side parts 8b and 8c are sufficient and the spring parts 8d and 8e are not necessarily provided. However, if there are the spring parts 8d and 8e, even before the power generating element 1 is housed in the battery case 2, the connected and fixed part between the connection part 7c and the positive electrode 1a can be lightly sandwiched so as not to be off, so that workability of assembly can be improved.

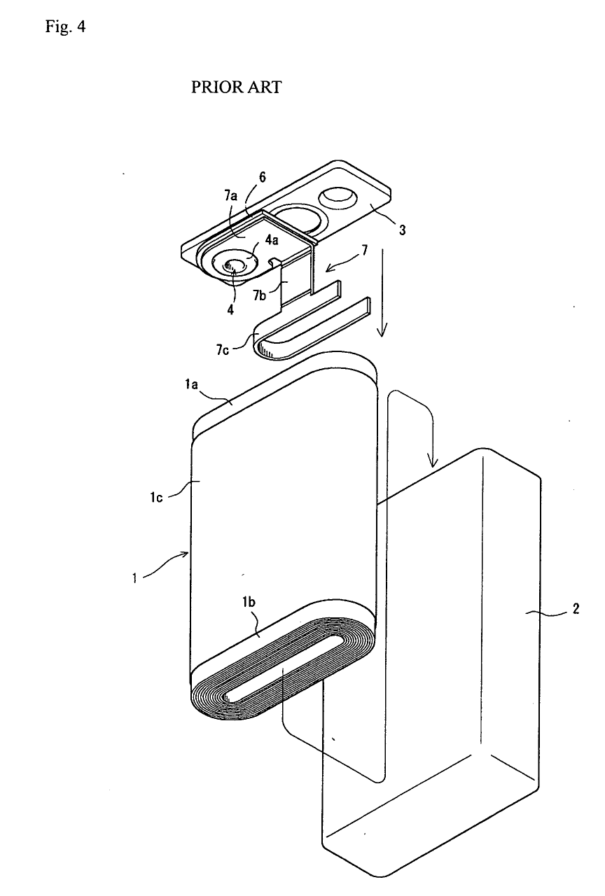

In the foregoing embodiment, the case of forming the connection part 7c of the positive electrode lead 7 in a U shape and ultrasonic-welding the aluminum foil of the positive electrode 1a to the outside of each of both plate pieces of the U shape, thereby widening the area of the connected and fixed part has been described above. However, the shape of the connection part 7c is arbitrary and can be constructed only by a single flat plate piece as shown in FIG. 3. In this case, it is sufficient for the insulating member 8 to sandwich only the connected and fixed part between the single plate piece of the connection part 7c and the aluminum foil of the positive electrode 1a. Consequently, the insulating member 8 can be also constructed by two members of the first side part 8b and the second side part 8c integrated with the center part, as shown in FIG. 3.

Although the case where the insulating member 8 is made of a resin has been described in the embodiment, the material may be an insulating material having a certain degree of rigidity, heat-resisting property, heat resistance and resistance to an electrolyte. Therefore, other materials such as hard rubber and ceramics can be also used. Further, although the case of fixing the insulating member 8 to the inside of the opening in the battery case 2 by press-fitting has been described in the foregoing embodiment, for example, the insulating member 8 may be loose-fit and, after that, fixed to the battery case 2 by an adhesive or the like.

In the foregoing embodiment, the case where the positive electrode lead 7 and the positive electrode terminal 4 are separate parts and are connected and fixed to each other by caulking, thereby obtaining conduction has been described. However, the means for connecting the positive electrode lead 7 and the positive electrode terminal 4 is arbitrary, and the positive electrode lead 7 may be constructed by a part of the part of the positive electrode terminal 4. Further, in the foregoing embodiment, the case where the positive electrode lead 7 is bent twice and the battery cover 3 is fit in the opening end of the battery case 2 has been described. The number of bending times of the positive electrode lead 7 is arbitrary.

Although the case of insulating and attaching the positive electrode terminal 4 to the battery cover 3 has been described in the embodiment, the positive electrode terminal 4 can be directly attached to the battery cover 3 insulated from the negative pole terminal so that the battery cover 3 can also have the positive electrode potential. The battery cover 3 itself can be constructed as a positive electrode terminal. Further, the positive electrode terminal 4 can be directly attached to the battery cover 3 of an insulator. Further, the case of sandwiching and fixing the connected and fixed part with the positive electrode 1a of the positive electrode lead 7 conducted to the positive electrode terminal by the insulating member 8 has been described in the foregoing embodiment. Alternately, a part connected and fixed to the negative electrode of the negative electrode lead which is electrically conducted to the negative electrode terminal provided in place of the positive electrode terminal 4 for the battery cover 3 can be sandwiched by the insulating member 8. Both of the positive and negative electrode leads can be sandwiched and fixed.

Although the power generating element 1 of the winding type having an elliptic cylindrical shape has been described in the foregoing embodiment, the shape of the winding is arbitrary. The invention can be similarly applied to a power generating element 1 of a stacked type. Further, although the nonaqueous electrolyte secondary battery has been described in the embodiment, the kind of the battery is also arbitrary.

### INDUSTRIAL APPLICABILITY

The present invention provides a battery including: a power generating element having a positive electrode, a negative electrode, and a separator; a battery case for housing the power generating element; a battery cover for closing the battery case; and a lead for electrically connecting a terminal provided for the battery cover and the positive electrode or the negative electrode, characterized in that a part in which the lead and the positive electrode or the negative electrode are electrically connected to each other is sandwiched by an insulating member.

With the configuration, the insulating member supports the positive electrode or the negative electrode. Consequently, at the time of bending the lead, the bending force is hardly transmitted to the part in which the positive electrode or the negative electrode and the lead are electrically connected to each other. As a result, the danger such that the positive electrode or the negative electrode and the lead are peeled off from each other is reduced. Moreover, the part in which the lead and the positive electrode or the negative electrode are connected to each other by the member is sandwiched, even if the battery is vibrated or shocked, the connection part between the lead and the positive electrode or the negative electrode in the battery is not easily damaged. When the battery is vibrated or shocked, the power generating element itself is not easily damaged.

The present invention is widely applied to batteries as described above and is used in the industries. Moreover, the industrial utility value of the present invention is extremely high.

1. A battery comprising:
a power generating element having a positive electrode, a negative electrode, and a separator;
a battery case for housing the power generating element;
a battery cover for closing the battery case;
a terminal provided for the battery cover;
a lead for electrically connecting the terminal and the positive electrode or the negative electrode; and
a member, which is fit in the battery case, and by which a part in which the lead and the positive electrode or the negative electrode are electrically connected to each other is sandwiched.

2. (canceled)

3. The battery according to claim 1, wherein the member presses the part in which the lead and the positive electrode or the negative electrode are electrically connected to each other.

4. The battery according to claim 1, wherein the member has insulating property.

5. The battery according to claim 1, wherein the member is adhered to the battery case.

6. The battery according to claim 1, wherein both of a part in which the positive electrode and the lead are electrically connected to each other and a part in which the negative electrode and the lead are electrically connected to each other are sandwiched by the member.

7. The battery according to claim 1, wherein the member is constructed by a plurality of members.

8. A method of manufacturing the battery according to claim 1, the method comprising:
a step of electrically connecting the lead to the positive electrode or the negative electrode;
a step of sandwiching a part in which the lead and the positive electrode or the negative electrode are electrically connected to each other by the member;
a step of housing the power generating element in the battery case; and
a step of bending the lead.

9. The manufacturing method according to claim 8, wherein the step of bending the lead is performed after the step of sandwiching the part in which the lead and the positive electrode or the negative electrode are electrically connected to each other by the member.

10. The battery according to claim 1, further comprising:
an aluminum foil which is a non-coating portion of the positive electrode and is projected in an upper end of the power generating element;
a copper foil which is a non-coating portion of the negative electrode and is projected in a lower end of the power generating element;
an inner bottom face provided for the battery case;
a positive lead as one of the lead, which connects the aluminum foil to the terminal; and
a negative lead as one of the lead, which connects the copper foil to the inner bottom face,
wherein the part is where the positive lead and the aluminum foil are electrically connected to each other.

11. The battery according to claim 1, further comprising:
an aluminum foil which is a non-coating portion of the positive electrode and is projected in a lower end of the power generating element;
a copper foil which is a non-coating portion of the negative electrode and is projected in an upper end of the power generating element;
an inner bottom face provided for the battery case;
a positive lead as one of the lead, which connects the aluminum foil to the inner bottom face; and
a negative lead as one of the lead, which connects the copper foil to the terminal,
wherein the part is where the negative lead and the copper foil are electrically connected to each other.

12. A method of manufacturing the battery according to claim 10, the method comprising:
a step of electrically connecting the positive lead to the aluminum foil and connecting the negative lead to the copper foil;
a step of housing the power generating element in the battery case;
a step of welding the negative lead to the inner bottom face;
a step of sandwiching the part in which the positive lead and the aluminum foil are electrically connected to each other by the member; and
a step of bending the positive lead.

13. The manufacturing method according to claim 12, wherein the step of bending the positive lead is performed after the step of sandwiching the part in which the positive lead and the aluminum foil are electrically connected to each other by the member.
